(19) United States
(12) Patent Application Publication
(10) Pub. No.: US 2026/0277641 A1
(43) Pub. Date: Sep. 17, 2026

(54) SCREEN CREATION SUPPORT DEVICE, SCREEN OPERATION SUPPORT DEVICE, AND COMPUTER-READABLE STORAGE MEDIUM

(71) Applicant: FANUC CORPORATION, Yamanashi (JP)

(72) Inventor: Takuya SAITOU, Yamanashi (JP)

(21) Appl. No.: 19/472,710

(22) PCT Filed: Apr. 27, 2023
(86) PCT No.: PCT/JP2023/016636

§ 371 Date: Oct. 6, 2025

(51) Int. Cl. G06F 9/451; G06F 3/04817; G06F 3/04842; G06F 8/38

(52) U.S. Cl. CPC G06F 9/453; G06F 3/04817; G06F 3/04842; G06F 8/38

(57) ABSTRACT

Provided is a screen creation support device that displays an operation screen of a control device on the basis of a screen configuration of an operation screen of a control device for controlling the industrial machine and a property of a component of the operation screen, detects, from a property of a component of the operation screen, a trigger that is an event accompanied by a user operation, an action caused by the trigger, and an operation target component affected by the action, creates help information in which a display state of the control device, an operation state of the industrial machine, propriety of execution of the trigger, an action, and the operation target component are associated with each other, refers to the help information, and displays the operation content to be a trigger superimposed on the operation target component of the operation screen in the currently displayed operation screen.

### RELATED APPLICATIONS

The present application is a National Phase of International Application No. PCT/JP2023/016636 filed Apr. 27, 2023.

### TECHNICAL FIELD

This disclosure relates generally to a screen creation support device, a screen operation support device, and a computer-readable storage medium.

### BACKGROUND ART

There is conventional software for creating screens for control devices of industrial machines. In the software for creating the screens for the control devices, components, such as buttons, text boxes and labels, are selected, and the selected components are combined to create a screen.

For each component, an operation for the component can be registered. The operation includes touch operation, software key operation, hardware key operation, and control panel operation.

### PRIOR ART DOCUMENT

### Patent Literature

[Patent Literature 1] PCT International Publication No. 2022/269764

### Means for Solving the Problem

A screen creation support device of the present disclosure includes: a screen layout storage unit that stores a screen layout representing placement of components on an operation screen of a control device which controls an industrial machine; a property storage unit that stores properties of the components on the operation screen; a screen creation unit that displays an operation screen being created so as to accept the screen layout and a setting of the properties of the components; a trigger information extraction unit that detects a trigger that is an event involving a user operation, an action caused by the trigger, and an action object component that is affected by the action from the properties of the components on the operation screen; a help information creation unit that creates help information by associating a display state of the control device, an operation state of the industrial machine, execution possibility of the trigger, the action, and the action object component with one another; a help information storage unit that stores help information in which the trigger as the event involving the user operation, the action caused by the trigger, the action object component affected by the action, the display state of the control device, the operation state of the industrial machine, and the execution possibility of the trigger are associated with one another; and a help information display unit that refers to the help information to display an operation content as the trigger among the contents on an operation screen currently displayed by superimposing it on the action object component on the operation screen.

### BRIEF DESCRIPTION OF THE DRAWINGS

FIG. 1 is a block diagram of a screen creation support device;

FIG. 2 is a layout diagram of a screen for screen creation;

FIG. 3 is a layout diagram of a screen for event registration;

FIG. 4 is a layout diagram of a screen for trigger registration;

FIG. 5 is a layout diagram of an operation screen of a control device;

FIG. 6 is an appearance diagram of icons;

FIG. 7 is a layout diagram of a screen presenting a triggering operation displayed on an operation screen;

FIG. 8 is a flowchart illustrating an operation of the screen creation support device;

FIG. 9 is a block diagram of a screen operation support device;

FIG. 10 is a layout diagram of the operation screen;

FIG. 11 is a layout diagram of an operation screen displaying help information;

FIG. 12 is a flowchart illustrating an operation of the screen operation support device; and

FIG. 13 is a hardware configuration diagram of the screen creation support device.

### DETAILED DESCRIPTION

According to the disclosure, screens for a control device are often created by an industrial machine manufacturer. Screen creation works involve providing users with information that teaches operation contents on screens, such as screen operation manuals and help screens. The creation works on the manuals and the help screens cause an increase in man-hours. Furthermore, the screens for a control device of an industrial machine changes depending on machine states and screen states of the industrial machine or the control device. It is therefore necessary to provide operation information that corresponds to the state of the control device.

Thus, in the field of control devices for industrial machines, there is a demand for providing operation content that corresponds to an operation screen during operation.

### First Embodiment

A description will be made about a screen creation support device 100 of a first embodiment. For example, the screen creation support device 100 is a personal computer (PC) in which screen creation software for a control device of an industrial machine is implemented. The screen creation support device 100 may be applied to a control device, such as a numerical controller.

The screen creation support device 100 is configured to extract operation information (hereinafter referred to as trigger) from component properties on a screen previously created, and associate the information with an action caused by a trigger and an icon of an operation content that can be the trigger so as to store this information as help information. There is a screen operation support device 200, about which will be described later, that displays the help information created by the screen creation support device 100 on an operation screen to provide help information appropriate to the operation screen currently displayed.

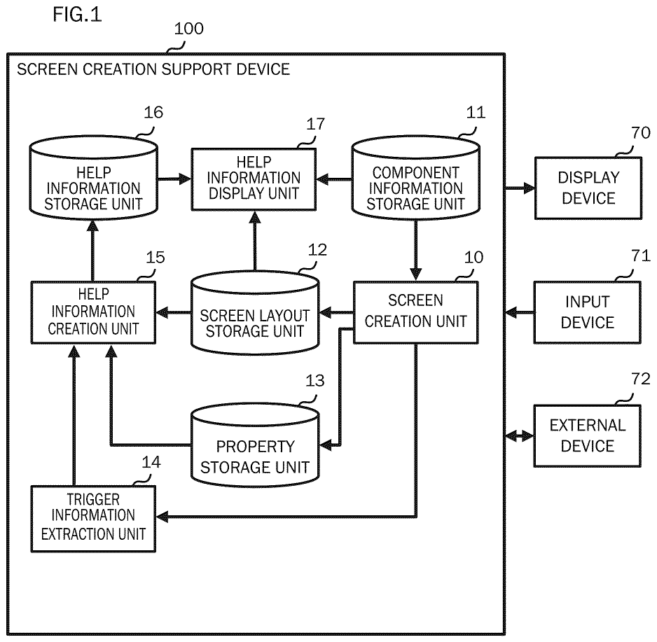

FIG. 1 is a block diagram of the screen creation support device 100. The screen creation support device 100 includes a screen creation unit 10, a component information storage unit 11, a screen layout storage unit 12, a property storage unit 13, a trigger information extraction unit 14, a help information creation unit 15, a help information storage unit 16, and a help information display unit 17.

The constituent elements of the screen creation support device 100 are classified according to their functions and may not be clearly distinguished by physical configurations and program configurations.

The screen creation unit 10 is configured to create an operation screen of an industrial machine by using a compound component formed by combining a discrete component and a discrete component, which are prepared beforehand, based on an editing operation performed by a screen creator. The editing operation by the screen creator may designate an on-screen placement of a discrete component and a compound component read from the component information storage unit 11. Alternatively, the editing operation may set properties of the discrete component and the compound component placed on the screen.

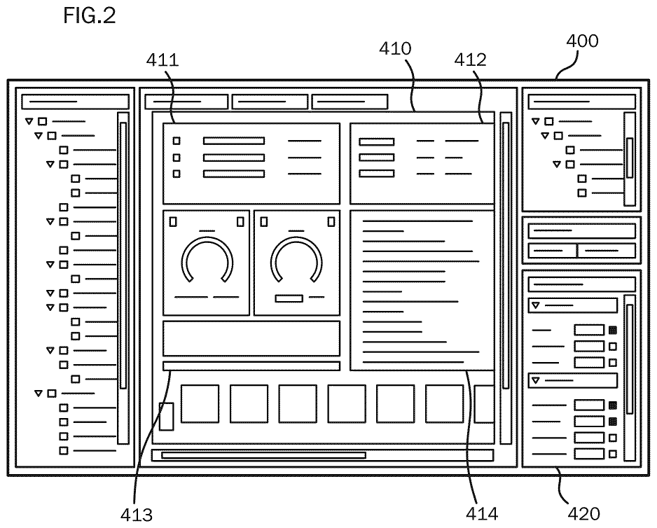

FIG. 2 shows an example of a screen-creation screen 400 that is displayed on a display device by the screen creation unit 10. The screen-creation screen 400 illustrated in FIG. 2 includes a screen layout creation area 410. In the screen layout creation area 410, four compound components 411, 412, 413, 414 and a plurality of discrete components are placed by the editing operation by the screen creator. The screen creation unit 10 accepts operations performed by the screen creator. On the basis of the operations by the screen creator, the screen creation unit 10 refers to the component information storage unit 11 to place necessary discrete components and compound components in the screen layout creation area 410.

The screen-creation screen 400 includes a property setting area 420. The property setting area 420 is for displaying the properties of the discrete components and the compound components 411, 412, 413, 414. The property includes, for instance, component ID, display/hide, valid/invalid, focus, position, size, display color, background color, title text. The screen creation unit 10 stores information about a created screen layout for the operation screen of the industrial machine in the screen layout storage unit 12. In addition, the screen creation unit 10 stores information about the properties of the screen components forming the operation screen of the industrial machine in the property storage unit 13.

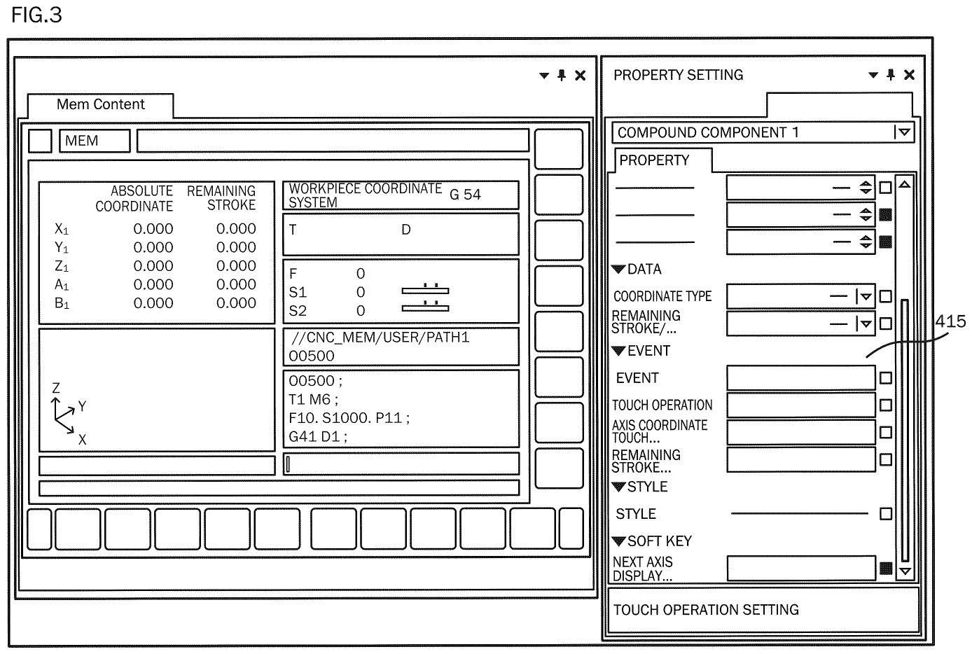

The properties of a component include an event that affects the component and a trigger to operate the component. FIG. 3 shows an example of a registration screen of an event. The property setting screen in FIG. 3 has an event setting area 415. Events are separated into user operation and non-user operation. A non-user operation is an event that does not involve the user operation. A user operation is an event that is raised by user operations on an operation screen, a control panel, a pendant, and the like. In this embodiment, the event involving the user operation is called “trigger”.

The event setting area is formed by setting selection buttons, such as “event setting”, “touch operation setting”, “axis coordinate touch operation setting”, and “remaining stroke touch operation setting”. The event setting accepts a setting of an event that causes a component to do an action.

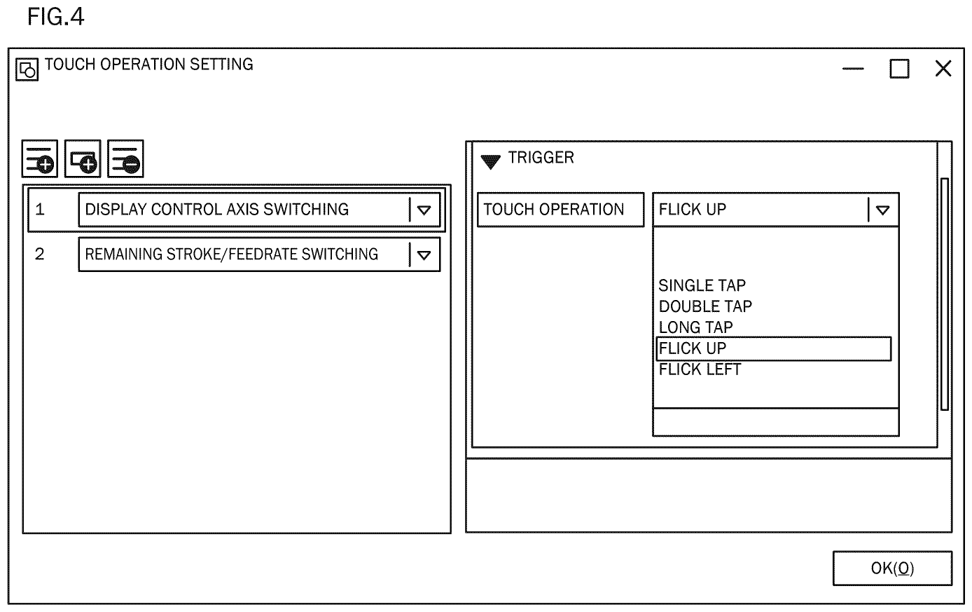

By way of example, when the button “touch operation setting” in FIG. 3 is selected, a trigger registration screen in FIG. 4 is displayed.

The registration screen in FIG. 4 consists of two screens, left and right. The left screen displays a list showing two actions, “display control axis switching” and “remaining stroke/feedrate changing”. The actions can be selected from a pull-down menu. The left screen in FIG. 4 enables the selection of the touch operation for conducting the action “display control axis switching”. The selectable touch operations are “single tap”, “double tap”, “long tap”, “flick up”, and “flick down”, and in here “flick up” is selected as the user operation.

As a property, a component, or operation object component, that accepts a triggering operation can also be selected, though it is not shown. For example, a button “coordinate changing” is selected as a trigger, and the icon for the selected button can be registered as an icon indicating an operation content.

The screen creation unit 10 further accepts a setting to associate a display state of the operation screen and an operation state of the industrial machine with execution possibility of a trigger.

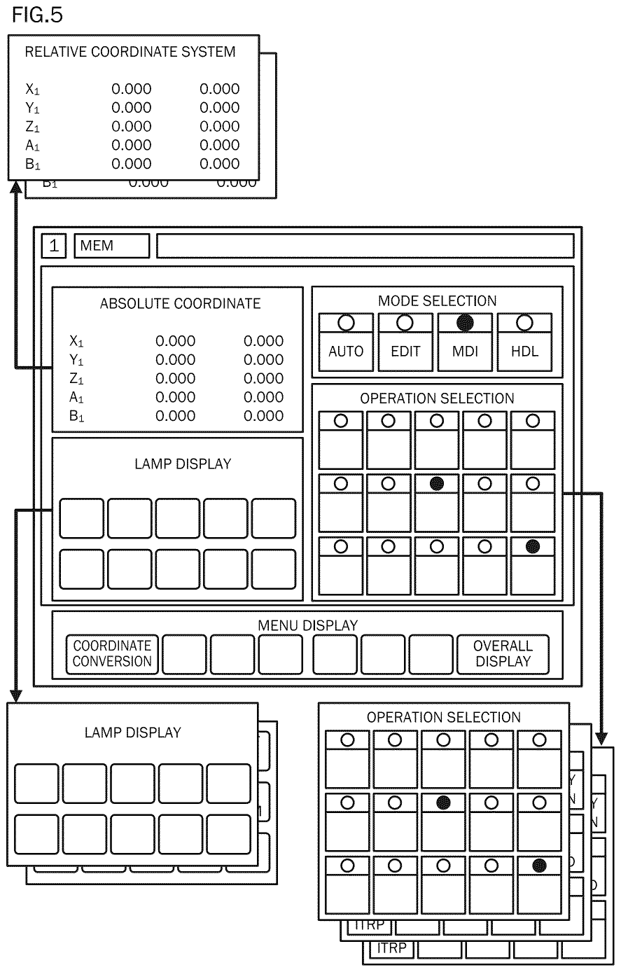

Now, the layout of the operation screen as well as a display state of the control device and the operation state of the industrial machine will be described. FIG. 5 shows an example of the operation screen of the control device. The operation screen in FIG. 5 consists of five compound components. The compound component at the upper left is “coordinate display component”, the compound component at the bottom left is “lamp display component”, the compound component at the upper right is “mode selection component”, the component at the bottom right is “operation selection component”, and the component at the bottom is “menu display component”.

In the display area of the coordinate display component at the upper left, four types of coordinate display components, namely an absolute coordinate system, a relative coordinate system, a machine coordinate system and a remaining stroke, are placed. A coordinate conversion button is provided to accept the switching of the coordinate display component. In the display area of the operation selection component at the bottom right, five compound components corresponding to modes are placed. The “mode selection component” has a plurality of buttons for accepting mode selections.

According to the user operation, a working state of the industrial machine, and the operation state of the industrial machine (modes), the component displayed on the operation screen is switched between “coordinate display component”, “lamp display component” and “operation selection component”.

The trigger execution possibility depends on whether the component is displayed/hidden, valid/invalid, with/without focus, and the mode. The mode is the operation state of the industrial machine. The mode includes “AUTO: memory working mode”, “EDIT: memory edit mode”, “MDI: Manual data input mode” and so on.

For example, the selection of “EDIT: memory edit mode” enables an edit of a machining program, and a component, such as program edit screen, that corresponds to the edit mode is displayed. Some components thus displayed are valid only when they are selected (have a focus). Furthermore, some components are set to invalid, that is, which are not valid even when selected. The invalid components do not act as a trigger. That is to say, it is “impossible” to execute the trigger.

The screen creation unit 10 stores the display state of the operation screen and the operation state of the industrial machine in association with the execution possibility of the trigger in the screen layout storage unit 12 or the property storage unit 13.

The trigger information extraction unit 14 is configured to extract information about the trigger from the properties of the component on the operation screen created by the screen creator. The information about the trigger can be read from, for instance, the property storage unit 13. The trigger information extraction unit 14 also extracts information about an action caused by the trigger. The information about the action also can be read from, for example, the property storage unit 13.

The information about the action can be also extracted from an execution function. The screen creation unit 10 provides execution functions, such as “copy function”, “paste function”, “workpiece end-face measurement function”, and “workpiece circularity measurement function”. The type of the execution function registered in the component tells what action is caused by the trigger.

In this embodiment, the component that accepts the user operation is referred to as an operation object component, the user operation is referred to as a trigger, the event caused by the trigger is referred to as an action, and the component affected by the action is referred to as an action object component. The operation object component and the action object component may be the same component.

The help information creation unit 15 is configured to create help information by associating the action object component, the operation object component (may be the same as the action object component), the display state of the control device, and the operation state of the industrial machine with the execution possibility of the trigger and the action, and store the information in the help information storage unit 16.

As described above, the operation object component, the action object component, the trigger, and the action in the help information are detected by the trigger information extraction unit 14. The display state of the control device, the operation state of the industrial machine, and the execution possibility of the trigger are read from the property storage unit 13.

The help information creation unit 15 stores help information in which the trigger and the action detected by the trigger information extraction unit 14 are associated with conditions that allows the execution of the trigger (component is displayed/hidden, valid/invalid, has focus or not) in the help information storage unit 16.

The help information may include icons that visually represent triggering operation contents. For example, the icons include icons indicating the types of the touch operations and icons indicating the types of the operation object components.

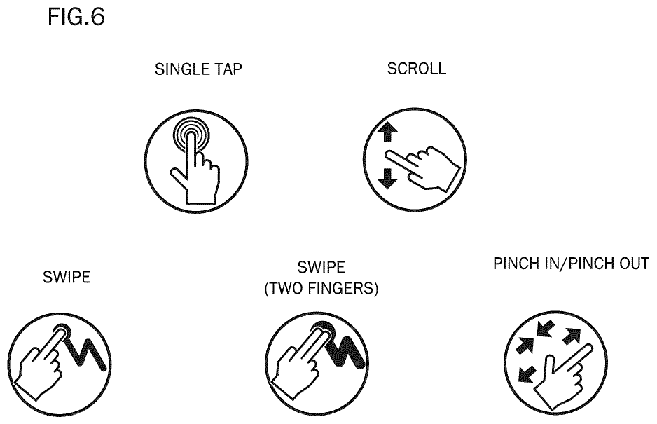

FIG. 6 shows an example of icons indicating the type of the touch operations. The icons indicating the types of the touch operations are “single tap”, “scroll”, “swipe”, “swipe (with two fingers)”, and “pinch in/pinch out”, by way of example.

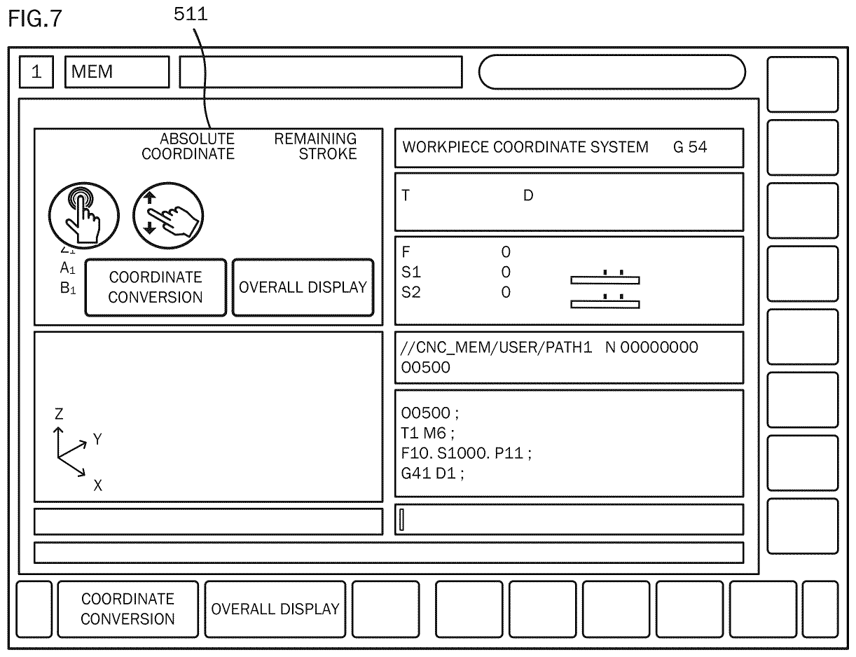

The help information display unit 17 is configured to display the help information in the display area of the action object component based on the help information. FIG. 7 shows an example of a display screen that displays help information of a coordinate display component 511 (action object component). The triggering operation that affects the coordinate display component 511 includes the touch operations of “single tap” and “scroll”, and button pressing of “coordinate conversion” and “overall display”. The display area of the coordinate display component 511 on the operation screen displays the icons indicating the triggering operations. It allows the creator of the operation screen to confirm how the triggering operations extracted by the trigger information extraction unit 14 is displayed on the operation screen.

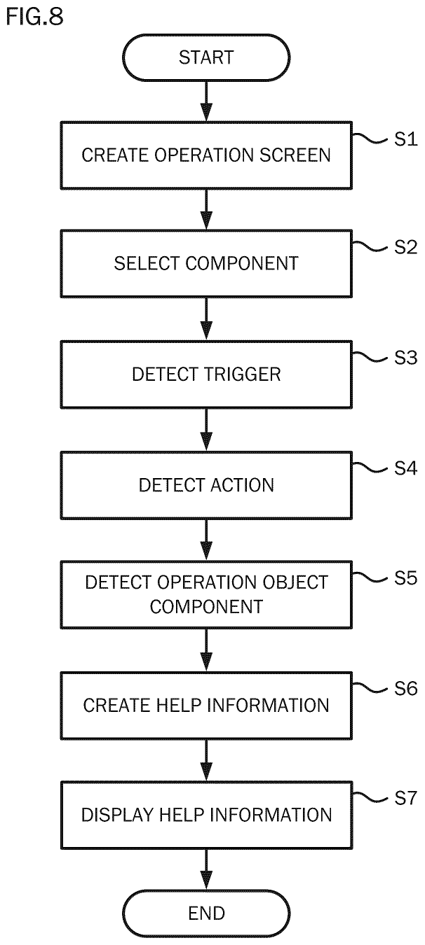

Next, an operation of the screen creation support device 100 will be described by referring to a flowchart shown in FIG. 8. First, the screen creator creates an operation screen (step S1). The operation screen may be created by the screen creation support device 100, or may be read in an operation screen created by another device. The screen layout storage unit 12 stores a screen layout of the created operation screens, and the property storage unit 13 stores the properties of the created components.

The trigger information extraction unit 14 selects any of the components forming the operation screen (step S2). The trigger information extraction unit 14 detects whether or not a trigger is set to the selected component (step S3). When the trigger is set, the selected component becomes an action object component.

The trigger information extraction unit 14 detects an action caused by the trigger (step S4). The action is defined by properties, an execution function and the like.

The trigger information extraction unit 14 detectes an operation object component (step S5). The operation object component and the action object component may be the same component.

The help information creation unit 15 creates help information in which the action object component, the operation object component, the trigger, the action, a display state of the control device, an operation state of the industrial machine, and execution possibility of the trigger are associated with one another, and stores the information in the help information storage unit 16 (step S6). The help information may include icons that indicate operation contents of the trigger.

Based on the created help information, the help information display unit 17 displays the help information on a display area for the action object component (step S7). The creator of the operation screen can confirm how the triggering operations extracted by the trigger information extraction unit 14 is displayed on the operation screen.

As described above, the screen creation support device 100 selects the component on the operation screen created by the creator, detects the trigger from the properties of the component, and detects the action caused by the trigger and the operation object component of the triggering screen operation. Then, the support device 100 creates the help information in which the action object component affected by the action, the trigger, the operation object component, the display state of the control device and the operation state of the industrial machine that enable the execution of the trigger are associated with one another.

There are many components to be displayed on the operation screen, and the amount of information will be enormous if all pieces of help information are displayed on the operation screen. Thus, the help information may be selectively displayed or hidden for each component.

### Second Embodiment

A description will be made about a screen operation support device 200 of a second embodiment. The screen operation support device 200 displays help information created by the screen creation support device 100 by superimposing it on an operation screen.

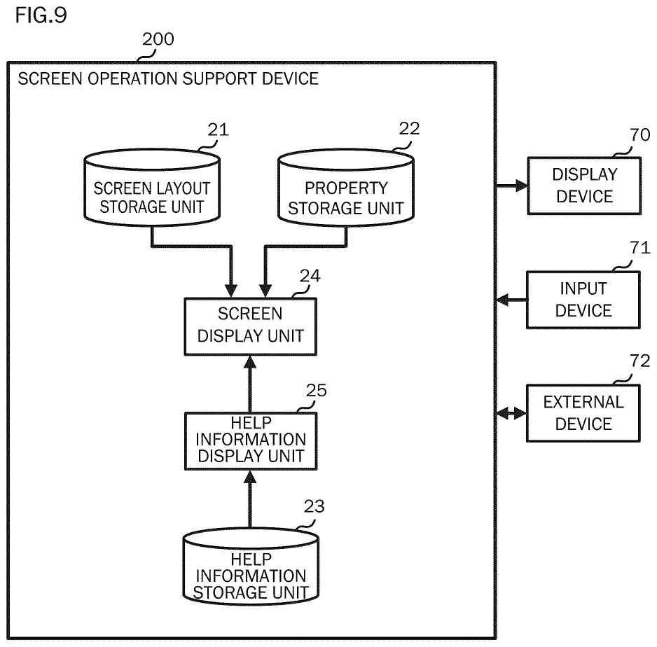

FIG. 9 is a block diagram of the screen operation support device 200. The screen operation support device 200 includes a screen layout storage unit 21, a property storage unit 22, a help information storage unit 23 a screen display unit 24, and a help information display unit 25.

The screen layout storage unit 21 is configured to store information about a screen layout of an operation screen. The property storage unit 22 is configured to store properties of components that form the operation screen. The property storage unit 22 also stores execution functions and others which are set for the components.

The screen display unit 24 is configured to display an operation screen of an industrial machine on a display device 70 of a control device according to screen layout information and the properties of the components. The screen display unit 24 acquires user operation signals, state information of the control device, state information of the industrial machine and others so as to switch operation screens.

The help information display unit 25 is configured to display help information created by the screen creation support device on the operation screen. The content of the help information changes depending on a display state of the operation screen of the control device, an operation state of a machine tool and the like. The help information display unit 25 acquires the display state of the operation screen and the operation state of the machine tool. On the basis of the display state of the operation screen and the operation state of the machine tool thus acquired, the help information display unit 25 extracts from the help information storage 23 a component (action object component) to which an executable trigger is set among the components on the operation screen currently displayed. The help information display unit 25 read from the help information storage unit 23 an action caused by the trigger and an operation object component that accepts a triggering user operation. The help information display unit 25 displays icons that visually represent triggering operation contents on the display device 70.

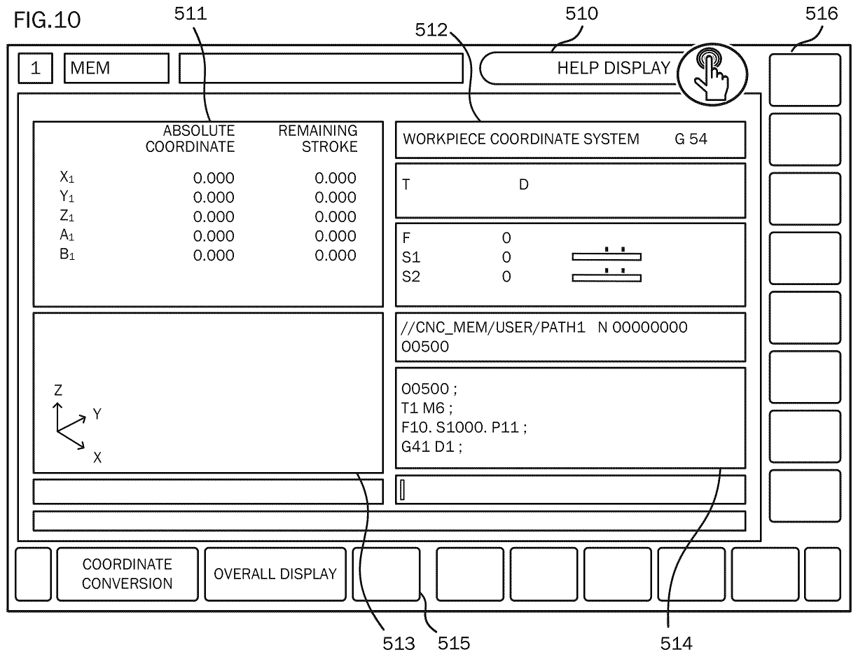

FIG. 10 shows an example of displaying the help information. The operation screen shown in FIG. 10 includes six compound components. In the center of the screen, four compound components are placed. The compound component at the upper left is a coordinate display component 511, the compound component at the upper right is a speed display component 512, the compound component at the bottom left is a machining path display component 513, and the compound component at the bottom right is a program display component 514. The mode of the industrial machine is “MEM: memory operation”. At the bottom and on the right side of the operation screen, a menu display component is placed. For purposes of illustration, the compound component at the bottom is referred to as a first menu display component 515, and a menu display component on the right side is referred to as a second menu display component 516.

At the upper right of the operation screen in FIG. 10, a long horizontal round button is placed. This button is a help display button 510. When a cursor (or finger in the case of a touch panel) is moved over the help display button 510, an icon indicating “click (or single tap in the case of a touch operation)” is displayed. The icon represents that a triggering operation is “click (single tap in the case of the touch operation)”.

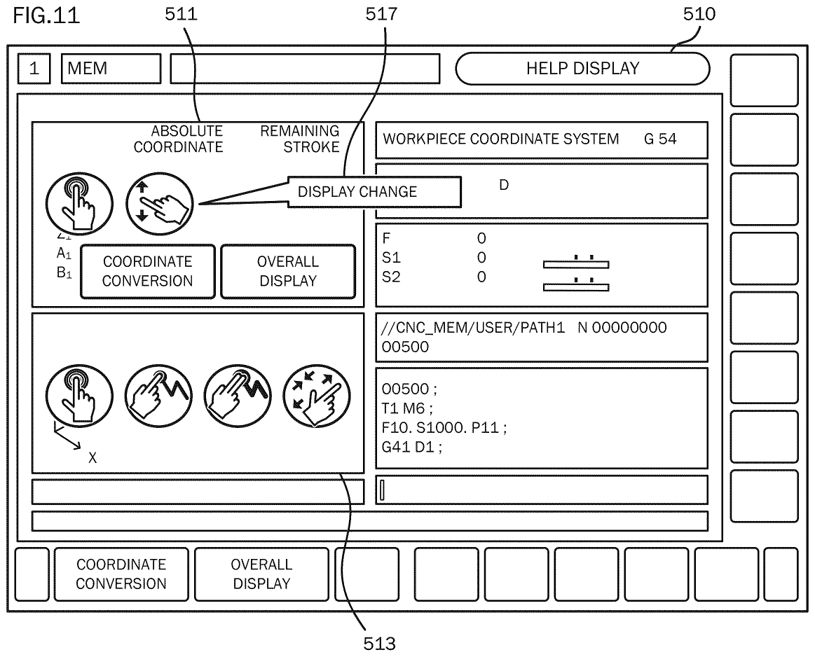

When the help display button 510 is operated, the help information is displayed on the operation screen. In FIG. 11, display areas of the coordinate display component 511 and the machining path display component 513 display icons that indicate operation contents. These icons visually display triggering operation contents. The icons are displayed in a display area of an action object component that is affected by the action.

The coordinate display component 511 at the upper left in FIG. 11 displays icons representing the touch operations “single tap” and “scroll” as well as buttons “coordinate conversion” and “overall display”. The icons visually represent the user operations (triggers) that affect the coordinate display component 511. The buttons “coordinate conversion” and “overall display” displayed as icons are operation object components that induce actions that affect the coordinate display component 511.

When the display area of the icons is selected by a cursor or a finger, a description about an action is displayed. In the coordinate display component 511 in FIG. 11, a description about an action, “display change”, is displayed in a display area 517 which is adjacent to the icon for the touch operation “scroll”.

In the machining path display component 513 at the bottom left in FIG. 11, the icons for the touch operations, “single tap”, “swipe”, “swipe (two fingers)” and “pinch in/pinch out”, are displayed. The icons visually represent that the triggers that affect the machining path display component 513 are the touch operations “single tap”, “swipe”, “swipe (two fingers)”, and “pinch in/pinch out”. In this example, the operation object component and the action object component are the same in all triggers.

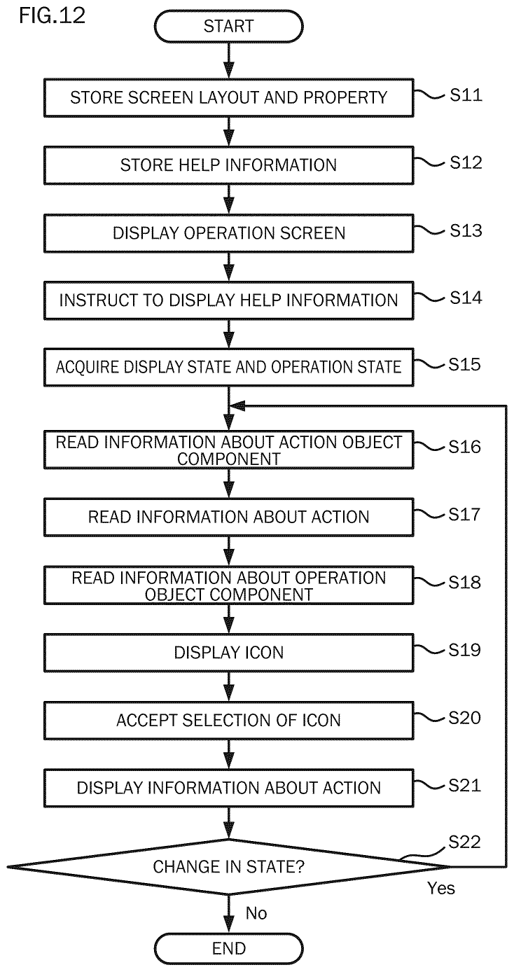

A description will be made about an operation of the screen operation support device 200 by referring to a flowchart shown in FIG. 12. An operation screen is installed in the screen operation support device 200. Consequently, the screen layout storage unit 21 stores the screen layout of the operation screen, and the property storage unit 22 stores the properties of components on the operation screen (step S11). When the operation screen is installed, help information created by the screen operation support device 200 is also stored in the help information storage unit 23 (step S12).

After the activation of the screen operation support device 200, the screen display unit 24 displays the operation screen on the display device 70 based on the screen layout and the properties of the components (step S13).

When an instruction is provided from a user to display the help information (step S14), the screen display unit 24 acquires a display state of the operation screen of the control device and an operation state of the machine tool (step S15). The help information display unit 25 reads from the help information storage unit 23 information about a component (action object component) to which an executable trigger is set among components on the operation screen currently displayed (step S16). The help information display unit 25 reads from the help information storage unit 23 information about an action caused by the trigger (step S17). In addition to that, the help information display unit 25 reads from the help information storage unit 23 information about an operation object component that accepts a triggering user operation (step S18). The action object component and the operation object component may be the same component.

The help information display unit 25 displays the icons visually representing triggering operation contents in the display area of the action object component (step S19). The help information display unit 25 accepts the selection of an icon (step S20), and upon the selection of the icon, displays the information about the action caused by the trigger (step S21).

The help information display unit 25 monitors the display state of the operation screen of the control device and the operation state of the machine tool, and when the states are changed (step S22: Yes), moves to step S16 to read from the help information storage unit 23 the component set with the executable trigger (action object component) in new states. In a case where there are no changes in the states (step S22: No), the help information display unit 25 continues to display.

As described above, the help information display unit 25 selects the component set with the executable trigger (action object component) among the components on the operation screen currently displayed according to the display state of the operation screen and the operation state of the machine tool. The help information display unit 25 displays the icon that visually represents the operation content of the trigger by superimposing it on the action object component. This can provide the help information about the operation screen currently displayed.

The help information display unit 25 displays the icon that visually represents the operation content of the trigger and the information about the action caused by the trigger represented by the icon in association with each other. This can provide the help information about the operation screen currently displayed.

The help information display unit 25 acquires the display state of the operation screen and the operation state of the machine tool at any time, so as to adapt the displayed help information to the change in the states. Since the help information adaptive to the states is provided, the burden of searching on the user can be reduced.

According to the screen creation support device 100 and the screen operation support device 200 of the illustrative embodiment, it is also possible to correspond to an update of the operation screen. That is to say, the screen creation support device 100 can automatically create the help information based on the screen layout of the updated operation screen and the properties. The process of updating the help information while checking the differences between the initial operation screen and new operation screen is very complicated. According to the illustrative embodiment, it is possible to reduce time and effort to update the help information.

Now, a hardware configuration of the screen creation support device 100 and the screen operation support device 200 to which the present disclosure is applied will be described. The screen creation support device 100 and the screen operation support device 200 have the approximately identical hardware configuration, and thus the description will be made only about the hardware configuration of the screen creation support device 100. Similar elements are marked with the same symbols.

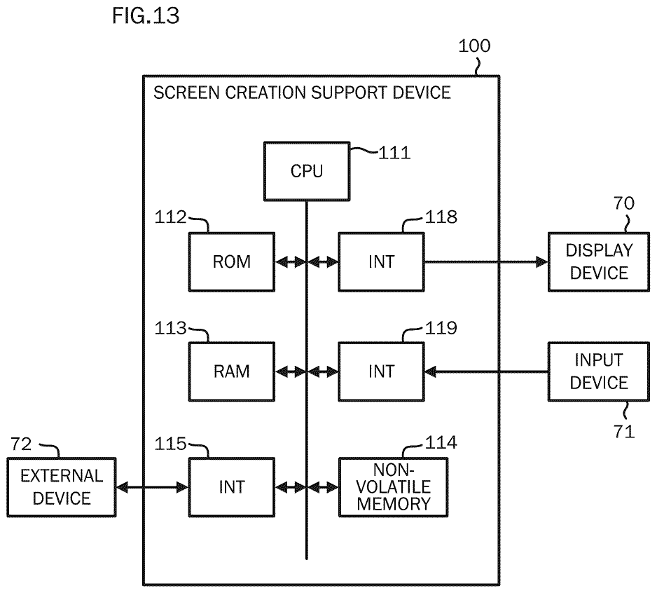

FIG. 13 show a hardware configuration of the screen creation support device 100. As shown in FIG. 13, the screen creation support device 100 includes a computer processing unit (CPU) 111 that totally controls the screen creation support device 100, a read-only memory (ROM) 112 that stores programs and pieces of data, and a random-access memory (RAM) 113 that temporarily expands pieces of data, the CPU 111 reading a system program stored in the ROM 112 via a bus to perform management processes of a machining program.

A non-volatile memory 114 is backed up by a battery, not shown, for example, so that storage conditions can be retained even when a power source of the screen creation support device 100 is turned off. The non-volatile memory 114 is configured to store programs read from an external device 72 via interfaces 115, 118 and 119 and various data about the user operations and others entered through an input device 70. The non-volatile memory 114 may store programs and pieces of data for executing block search in the present disclosure. Furthermore, the display device 70 is configured to display the various data.

The interface 115 is configured to connect the screen creation support device 100 with the external device 72, such as an adaptor. From the external device 72, programs, various parameters and the like are read in.

The present disclosure has been described in detail, but is not limited to the above-described individual embodiments. Thus, various additions, substitutions, modifications, partial deletions and so on may be made to these embodiments without departing from the gist of the disclosure or the spirit of the disclosure as derived from the contents described in the appended claims and their equivalents. Furthermore, these embodiments can be implemented by combining them. For example, the order of the operations and the order of the processes in these embodiments are provided by way of example, and thus are not limited thereto.

Supplementary notes on the above-described embodiments and their variations will be presented below.

### Supplementary Note 1

A screen creation support device (100) includes: a screen layout storage unit (12) that stores a screen layout that represents placement of components on an operation screen of a control device which controls an industrial machine; a property storage unit (13) that stores properties of the components on the operation screen; a screen creation unit (10) that displays an operation screen being created so as to accept the screen layout and a setting of the properties of the components; a trigger information extraction unit (14) that detects a trigger that is an event involving a user operation, an action caused by the trigger, and an action object component that is affected by the action from the properties of the components on the operation screen; a help information creation unit (15) that creates help information by associating a display state of the control device, an operation state of the industrial machine, execution possibility of the trigger, the action, and the action object component with one another; a help information storage unit (16) that stores help information in which the trigger as the event involving the user operation, the action caused by the trigger, the action object component affected by the action, the display state of the control device, the operation state of the industrial machine, and the execution possibility of the trigger are associated with one another; and a help information display unit (17) that refers to the help information to display an operation content as the trigger among operation contents on an operation screen currently displayed by superimposing it on the action object component on the operation screen.

### Supplementary Note 2

The trigger information extraction unit (14) extracts an operation object component that accepts a triggering operation, and the help information creation unit (15) associates the triggering operation with the operation object component.

### Supplementary Note 3

The help information creation unit (15) associates the trigger with an icon that visually represents the triggering operation content.

### Supplementary Note 4

The screen creation support device (100) includes the screen creation unit (10) that accepts a component placement and the setting of the properties of the components, and accepts the creation of an operation screen of the control device which controls the industrial machine.

### Supplementary Note 5

A screen operation support device (200) includes: a screen layout storage unit (21) that stores a screen layout that represents placement of components on an operation screen of a control device which controls an industrial machine; a property storage unit (22) that stores properties of the components on the operation screen; a screen display unit (24) that displays the operation screen of the control device based on the screen layout and the properties of the components; a help information storage unit (23) that stores help information in which a trigger that is an event that involves a user operation, an action caused by the trigger, an action object component that is affected by the action, a display state of the control device, an operation state of the industrial machine, and execution possibility of the trigger are associated with one another; and a help information display unit (25) that acquires the display state of the control device and the operation state of the industrial machine, refers to the help information to extract a component, to which an executable trigger is set, from an operation screen currently displayed, and displays an operation content as the trigger by superimposing it on the action object component on the operation screen.

### Supplementary Note 6

The help information display unit (25) displays the icon representing the operation content as the trigger by superimposing it on the action object component on the operation screen.

### Supplementary Note 7

The help information display unit (25) refers to the help information in response to changes in the display state of the control device and the operation state of the industrial machine, extracts the component, to which the executable trigger is set, from the operation screen currently displayed, and displays the operation content as the trigger by superimposing it on the action object component on the operation screen.

### Supplementary Note 8

A component that initiates help display is placed on the operation screen, and the help information display unit (25) acquires the display state of the control device and the operation state of the industrial machine in response to a user operation on the component initiating the help display, refers to the help information to extract the component, to which the executable trigger is set, from the operation screen currently displayed, and displays the operation content as the trigger by superimposing it on the action object component on the operation screen.

### Supplementary Note 9

The help information display unit (25) displays the operation content as the trigger in text format.

### Supplementary Note 10

A computer-readable storage medium (112, 113, 114) stores commands that allow one or more processors (111) to: store a screen layout that represents placement of components on an operation screen of a control device which controls an industrial machine, store properties of the components on the operation screen; display the operation screen of the control device based on the screen layout and the properties of the components; detect a trigger that is an event involving a user operation, an action caused by the trigger, and an action object component that is affected by the action from the properties of the components on the operation screen; create help information by associating a display state of the control device, an operation state of the industrial machine, execution possibility of the trigger, the action, and the action object component with one another; refer to the help information to display an operation content as the trigger among operation contents on an operation screen currently displayed by superimposing it on the action object component on the operation screen.

1. A screen creation support device, comprising:
a screen layout storage unit that stores a screen layout representing placement of components on an operation screen of a control device which controls an industrial machine;
a property storage unit that stores properties of the components on the operation screen;
a screen creation unit that displays an operation screen being created so as to accept the screen layout and a setting of the properties of the components;
a trigger information extraction unit that detects a trigger that is an event involving a user operation, an action caused by the trigger, and an action object component that is affected by the action from the properties of the components on the operation screen;
a help information creation unit that creates help information by associating a display state of the control device, an operation state of the industrial machine, execution possibility of the trigger, the action, and the action object component with one another;
a help information storage unit that stores help information in which the trigger as the event involving the user operation, the action caused by the trigger, the action object component affected by the action, the display state of the control device, the operation state of the industrial machine, and the execution possibility of the trigger are associated with one another; and
a help information display unit that refers to the help information and displays an operation content as the trigger among operation contents on an operation screen currently displayed by superimposing it on the action object component on the operation screen.

2. The screen creation support device according to claim 1, wherein the trigger information extraction unit extracts an operation object component that accepts a triggering operation, and
the help information creation unit associates the triggering operation with the operation object component.

3. The screen creation support device according to claim 1, wherein the help information creation unit associates the trigger with an icon that visually represents the operation content as a trigger.

4. The screen creation support device according to claim 1, comprising a screen creation unit that accepts a component placement and a setting of the properties of the components, and accepts creation of the operation screen of the control device which controls the industrial machine.

5. A screen operation support device, comprising:
a screen layout storage unit that stores a screen layout that represents placement of components on an operation screen of a control device which controls an industrial machine;
a property storage unit that stores properties of the components on the operation screen;
a screen display unit that displays the operation screen of the control device based on the screen layout and the properties of the components;
a help information storage unit that stores help information in which a trigger that is an event that involves a user operation, an action caused by the trigger, an action object component that is affected by the action, a display state of the control device, an operation state of the industrial machine, and execution possibility of the trigger are associated with one another; and
a help information display unit that acquires the display state of the control device and the operation state of the industrial machine, refers to the help information to extract a component, to which an executable trigger is set, from an operation screen currently displayed, and displays an operation content as the trigger by superimposing it on the action object component on the operation screen.

6. The screen operation support device according to claim 5, wherein the help information display unit displays the icon representing the operation content as the trigger by superimposing it on the action object component on the operation screen.

7. The screen operation support device according to claim 5, wherein the help information display unit refers to the help information in response to changes in the display state of the control device and the operation state of the industrial machine, extracts the component, to which the executable trigger is set, from the operation screen currently displayed, and displays the operation content as the trigger by superimposing it on the action object component on the operation screen.

8. The screen operation support device according to claim 5, wherein a component that initiates help display is placed on the operation screen, and the help information display unit acquires the display state of the control device and the operation state of the industrial machine in response to a user operation on the component initiating the help display, refers to the help information to extract the component, to which the executable trigger is set, from the operation screen currently displayed, and displays the operation content as the trigger by superimposing it on the action object component on the operation screen.

9. The screen operation support device according to claim 5, wherein the help information display unit displays the operation content as the trigger in text format.

10. A computer-readable storage medium that stores commands that allow one or more processors to:
store a screen layout that represents placement of components on an operation screen of a control device which controls an industrial machine;
store properties of the components on the operation screen;
display the operation screen of the control device based on the screen layout and the properties of the components;
detect a trigger that is an event that involves a user operation, an action caused by the trigger, and an action object component that is affected by the action from the properties of the components on the operation screen;
create help information by associating a display state of the control device, an operation state of the industrial machine, execution possibility of the trigger, the action, and the action object component with one another; and
refer to the help information to display an operation content as the trigger among operation contents on an operation screen currently displayed by superimposing it on the action object component on the operation screen.
